(19) United States
(12) Patent Application Publication
(10) Pub. No.: US 2006/0248508 A1
(43) Pub. Date: Nov. 2, 2006

(54) Method and system for applet extensibility application program interface (API)

(75) Inventor: Mark Steven Jeghers, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/118,245

(22) Filed: Apr. 29, 2005

(51) Int. Cl. G06F 9/44

(52) U.S. Cl. 717/114

(57) ABSTRACT

Applet extensibility techniques are provided for customizing an applet by adding custom pages to the applet without changing an original file of the applet. The original file and an extension file, which includes custom pages and an object, are downloaded to a client computer having the applet running thereon. The extension file can then be integrated into the applet by using applet tag parameters to determine the name of the object in the extension file, retrieving the object from the extension file, loading classes specified in the object from the extension file into the applet, and instantiating each class in the applet as a page object based on information provided by the object.

### TECHNICAL FIELD OF THE INVENTION

The present invention generally relates to object-oriented programming and, more particularly, to techniques for applet extensibility.

### BACKGROUND OF THE INVENTION

Java is a general purpose object-oriented programming language which can be used in a distributed environment such as the Internet.

In object oriented programming, objects are what actually run in the computer (e.g., the modular units of code that make up the inner workings of a process). Each object is made into a generic class (or “type”) of object and even more generic classes are defined so that objects can share models and reuse the class definitions in their code. Each object is an instance of a particular class or subclass with the class's own methods or procedures and data variables. Each object contains the data variables of the class it is an instance of. The object's methods are designed to handle the actual values that are supplied to the object when the object is being used. Among other characteristics, a Java object can take advantage of being part of a class of objects and inherit code that is common to the class. A Java object contains limited and well-controlled references to data external to the object itself or other known objects. This ensures that an instruction does not contain an address of data storage in another application or in the operating system itself. This helps to prevent the program and perhaps the operating system itself from terminating or “crashing.”

A method refers to a programmed procedure that is defined as part of a class and included in any object of that class. A class (and thus an object) can have more than one method. A method in an object can only have access to the data known to that object, which ensures data integrity among the set of objects in an application. A method can be re-used in multiple objects. A method can be thought of as one of the object's capabilities or behaviors.

A class is a template definition of the methods and variable in a particular kind of object. Thus, an object is a specific instance of a class; it contains real values instead of variables. A class can have subclasses that can inherit all or some of the characteristics of the class. In relation to each subclass, the class becomes the superclass (or “base class”). Subclasses can also define their own methods and variables that are not part of their superclass.

Java source code files with a java extension are typically compiled into a format known as bytecode. Bytecode files with a .class extension can be run on any entity having a Java virtual machine (JVM). Java bytecode is independent of the platform. Most web browsers include a JVM. The JVM interprets the bytecode (i.e., compiled Java source code files) into code that will run on real computer hardware. The JVM instruction set is stack-oriented, with variable instruction length. Unlike some other instruction sets, the JVM instruction set supports object-oriented programming directly by including instructions for object method invocation similar to subroutine call in other instruction sets. The JVM also makes a number of checks on each object to ensure integrity. The JVM may optionally include a just-in-time (JIT) compiler which directly converts the bytecode into faster machine language instructions or “executable code” as an alternative to interpreting one bytecode instruction at a time.

Java Applets

Java can be used to create complete applications that may run on a single computer or be distributed among servers and clients in a network. Java can also be used to build a small application modules sometimes referred to as Java applets for use as part of a Web page. An applet refers to an application program that can be sent along with a Web page to a user. An applet that comes as part of a Web page may include several files, each of which would have to be downloaded along with the Web page. Java applets can perform interactive animations, immediate calculations, or other simple tasks without having to send a user request back to the server.

Applets written in Java can be downloaded by any computer and make it possible for a Web page user to interact with the Web page. Applets run inside the browser's JVM and are typically embedded in an HTML page on a Web site. When users connect to a Web server that uses Java, they can download an applet onto their computers from the Web server, and the applet can then be executed or run on a computer from within a Java-compatible Web browser, such as Netscape Navigator or Microsoft Internet Explorer. The applet then runs on the computer's own processor via a Java Virtual Machine (JVM) program. In addition to being executed at the client rather than the server, a Java applet has other characteristics which make it run fast. Moreover, Java applets will run on almost any operating system without requiring recompilation.

Graphical User Interfaces (GUIs)

Many operating systems provide a graphical user interface (GUI). Applications typically use the elements of the GUI that come with the operating system and add their own graphical user interface elements and ideas. Elements of a GUI can include things such as windows, pull-down menus, buttons, scroll bars, iconic images, wizards, and the mouse. With the increasing use of multimedia as part of the GUI, sound, voice, motion video, and virtual reality interfaces can be part of the GUI for many applications. When creating an application, many object-oriented tools exist that facilitate writing a graphical user interface. Each GUI element can be defined as a class widget from which object instances can be created in an application. Prepackaged methods used by an object can be modified to respond to user stimuli.

Application Program Interfaces (APIs)

While a “GUI” gives a visual interface for a user to operate a program, an “application program interface” (API) is used by the programmer internally to access operating system services and features. When writing an application program, a programmer uses an API to make formal requests for services and to communicate with other programs. The API relates to the specific method prescribed by a computer operating system or by an application program by which a programmer writing the application program can make requests of the operating system or another application.

A Java applet typically resides on a Web server and is embedded on a Web page. In one implementation, the web server can be incorporated into, for example, a wireless switch. When a third party client uses a browser to connect to the wireless switch, the applet can be downloaded into the client's computer. The applet runs inside a browser page and provides a GUI which allows the third party client to configure, manage and set up the wireless switch by selecting options and settings of the wireless switch.

In some cases, third parties such as, vendors and development partners, seek to extend certain applet features. For instance, a third party may want to add new features such as such as custom pages into a GUI. However, to do so, the third party must alter or modify the core applet source code to customize the deployed GUI applet. For the original manufacturer of the core applet, altering or disassembly of the original applet's core source code can be undesirable since it increases the number of different versions of applet source code which exist; also, quality control problems can arise with the proliferation of many applet variants.

Thus, there is a need for an applet which is extensible so that unpredictable needs of third parties, such as vendors and developers, can be supported. It would be desirable to provide techniques which allow the third party to customize or modify the applet without impacting the applet's core source code. For example, it would be desirable to provide techniques which allow the third party to add new custom pages to a GUI applet without impacting the applet's core source code. Similarly, it would also be desirable to provide techniques which allow the third party to remove existing pages from the GUI applet without impacting the applet's core source code. Other desirable features and characteristics of the present invention will become apparent from the subsequent detailed description and the appended claims, taken in conjunction with the accompanying drawings and the foregoing technical field and background.

### SUMMARY OF THE INVENTION

According to one exemplary implementation, applet extensibility techniques are provided for customizing an applet by adding custom pages to the applet without changing an original file of the applet. The original file and an extension file, which includes custom pages and an object, are downloaded to a client computer having the applet running thereon. The extension file can then be integrated into the applet by using applet tag parameters to determine the name of the object in the extension file, retrieving the object from the extension file, loading classes specified in the object from the extension file into the applet, and instantiating each class in the applet as a page object based on information provided by the object.

### BRIEF DESCRIPTION OF THE DRAWINGS

The present invention will be described in conjunction with the following drawing figures, wherein like numerals denote like elements, and

FIG. 1 is a block diagram of an applet extensibility system according to one exemplary embodiment which allows customization of an applet by adding custom pages from an extension Java archive (JAR) file to the applet without changing an original Java archive (JAR) file of the applet;

FIG. 2 is a block diagram of the applet extensibility system of FIG. 1 which illustrates techniques for retrieving a page manifest object from an extension JAR file when customizing an applet;

FIG. 3 is a block diagram of the applet extensibility system of FIGS. 1 and 2 which illustrates techniques for loading classes specified in the page manifest object from the extension JAR file into the applet when customizing the applet;

FIG. 4 is a block diagram of the applet extensibility system of FIGS. 1 through 3 which illustrates techniques for plugging each class into the applet when customizing the applet;

FIG. 5 is a flow chart showing an exemplary method of customizing an applet by adding custom pages to the applet without changing an original Java archive (JAR) file of the applet according to one exemplary embodiment; and

FIG. 6 is a flow chart showing an exemplary method of integrating an extension JAR file into an applet according to one exemplary embodiment.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. As used herein, the word “exemplary” means “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

As used herein, a Java Archive (JAR) file generally refers to a file which can contain class, image, text, and/or sound files for a Java applet typically gathered into a single file and compressed for faster downloading to a Web browser. By putting the applet components in a single file and compressing that file, download time is saved. The JAR file format is based on the popular zip file format.

Embodiments of the present invention provide methods and systems for implementing a Java-based applet extensibility architecture and extensibility APIs which can allow a third party, such as a vendor or developer, to customize or “extend” particular modules of an applet or applet features. A third party can change the functionality of or extend the applet by adding new applet features to the applet without having to alter or change the original JAR files or “core source code” of the applet. In one implementation, the third party can add new custom pages to existing pages of a deployed Graphical User Interface (GUI).

A Web page of applet can be updated to include a new, separate extension Java archive (JAR) file which includes the new custom pages and a class name of a page manifest object. Definitions of the new custom pages are provided in the page manifest object. At runtime, the extension JAR file is deployed, and the page manifest object and new custom pages can be dynamically loaded and installed by the applet to seamlessly add the new custom pages into the original applet. By modifying of the index.html file of the applet to include new applet parameters, the applet can find and load the extension JAR file. In addition, APIs are provided which allow the new custom pages to read and write SNMP values without excessive difficulty.

As such, the original applet JAR files do not have to be modified or rebuilt which eliminates the need for the third party to alter/disassemble the original applet's original JAR files or “core source code.” This reduces the number of different versions of applet source code which will be created. For complete seamlessness, the “standard pages,” already built into the default Applet, can use the same API.

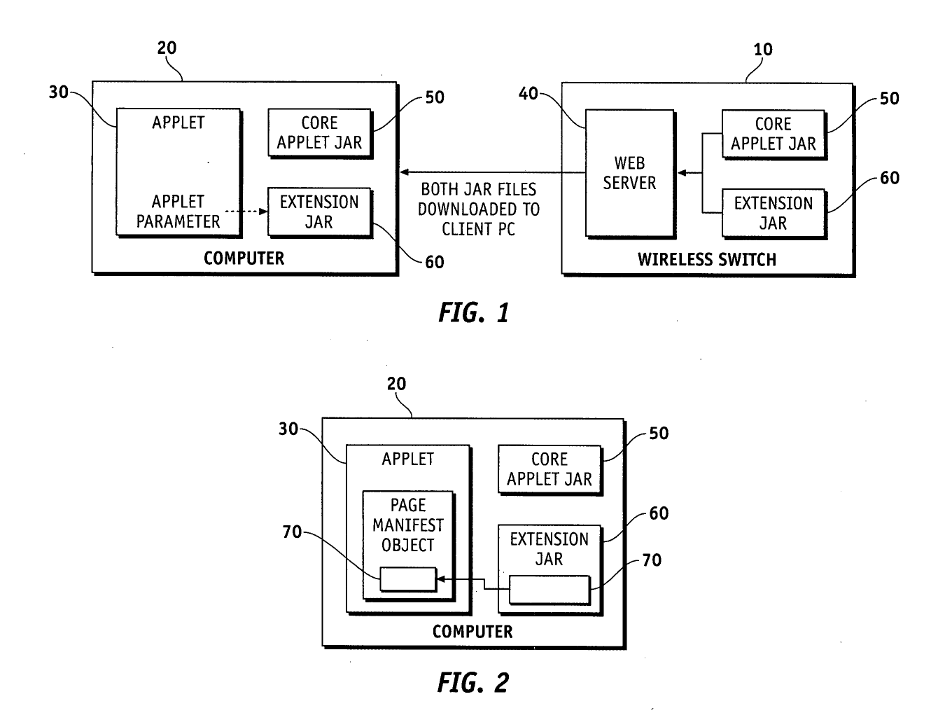

FIG. 1 is a block diagram of an applet extensibility system according to one exemplary embodiment which allows customization an applet by adding custom pages from an extension Java archive (JAR) file to the applet without changing an original Java archive (JAR) file of the applet.

The system comprises a wireless switch 10 which communicates with a client computer 20. As used herein, the term “wireless switch” refers to a device that channels incoming data from any of multiple input ports to the specific output port that will take the data toward its intended destination, some of which can be “wireless” in nature. A wireless switch typically performs the data-link or layer 2 functions and determines, from an IP address in each packet, which output port to use for the next part of its trip to the intended destination.

To configure a wireless switch, a manufacturer provides a GUI applet which includes a number of pages. This GUI applet can be implemented using pages associated with the original Java archive (JAR) file 50. Using the pages provided by the applet 30, the third party can set parameters and other characteristics of the wireless switch. However, in some cases, the third party wishes to modify the applet 30 so that the GUI can include additional pages in addition to the “core” pages associated with the original Java archive (JAR) file 50. Conventionally, to implement the new pages or other changes to the applet, the third party had to alter or modify the core source code of the core applet JAR file 50. Unfortunately, this results in a number of different versions of applet source code which can make trouble shooting of the applet and the wireless switch unnecessarily difficult.

According to an embodiment of the invention, a new, separate extension Java archive (JAR) file 60 is provided. A Web page of applet 30 can be updated to include the extension Java archive (JAR) file 60 which includes new custom pages and a class name of a page manifest object 70. The page manifest object 70 includes definitions of the new custom pages. The page manifest object 70 and new custom pages can be dynamically loaded and installed by applet, at runtime, to seamlessly add the new custom pages into the original applet.

To implement a new extension page, a new Java class can be created for each new extension page. This page can implement a “Page Manifest” interface. A source file, ContentTemplatejava, can be used as a starting point template for a new page. The Java “page manifest” interface defines the page manifest object 70 which delivers a manifest of classes that will be loaded and eventually instantiated in the applet. This interface retrieves class objects for all types of pages which will be plugged into the applet 30. The classes implement a Java “page extension” interface for “plug-in pages” which defines custom “pluggable” pages which are provided in extension JAR file 60.

According to one implementation as shown, for example, in FIG. 1, the wireless switch 10 comprises a web server 40, the original Java archive (JAR) file 50 and the extension JAR file 60.

The extension JAR file 60 can be deployed on a Web page with the original applet JAR file 50. The extension JAR file 60 stores new features such as new extension or custom pages which the third party wants to appear with the GUI on a screen, and a manifest, which is a list that documents the new features or pages and which describes new additional pages (additional modules of code) that can be added to the GUI as well as additional information about the additional pages. At start-up, the applet 30 can look at additional modules of code added by a third party and reach into the additional modules and extract the “manifest.”

In one implementation, the extension JAR file 60 comprises custom pages and a page manifest object 70 which implements an interface of page manifests. The page manifest object 70 comprises definitions of the additional or new extension GUI pages and supporting Java classes to be used with the extension GUI pages. For persistence, the extension JAR file 60 can use Simple Network Management Protocol (SNMP) operations directed to the wireless switch 10. The SNMP is a protocol governing network management and the monitoring of network devices and their functions. SNMP is described formally in the Internet Engineering Task Force (IETF) Request for Comment (RFC) 1157 and in a number of other related RFCs.

The new extension pages can be created by creating a class implementing the “PageManifest” interface, and which contains a list of all the new classes created to implement the new pages. A “TreeInsertionPoint” interface provides a helper object for each page that will be plugged into the applet 30. The TreeInsertionPoint interface describes the name of the tree where the new item should be installed and a location within that tree where a page should have a tree-item installed (which the user uses to invoke the new page). For each new extension page to be created, a corresponding “TreeInsertionPoint” object is created which describes what kind of tree entry will be created for each new extension page. In one implementation, these objects can be implemented as inner classes within the page manifest object 70. The classes are ideally made part of a new package which is different from any package names already used in the applet or other extensions. The classes and any image files the classes require can then be compiled into a new extension JAR file 60. The new extension JAR file 60 can then be deployed into the web server 40 or directory where the applet 30 is being served.

Once the extension JAR file 60 is created, the client computer 20 is configured to download the original Java archive (JAR) file 50 and the extension JAR file 60 from the Web server 40. The applet 30 includes an HTML file or page which runs on the client computer 20. Applet parameters cause the browser to import the extension JAR file 60 and instruct the applet 30 to find the manifest. This allows the third party to specify changes to the HTML page. Once properly deployed, the extension JAR file 60 will be integrated or “wired” into the running applet 30 upon applet start-up so that new custom extension pages can be added to the applet 30. The applet 30 can integrate the extension JAR file 60 into the applet by executing a number of steps, as will now be described with reference to FIGS. 1-4.

As shown in FIG. 1, the client computer 20 downloads the JAR files 50, 60 from the web server 40. The original JAR file 50 includes basic code for running the applet 30 which the client computer 20 uses to begin running the applet 30.

FIG. 2 is a block diagram of the applet extensibility system of FIG. 1 which illustrates techniques for retrieving a page manifest object 70 from the extension JAR file 60. Once the applet 30 is running on the client computer 20, the applet 30, having knowledge of the extension JAR file 60, can retrieve the page manifest object 70 from the extension JAR file 60.

The applet's HTML file is modified so that the new extension JAR file 60 can be loaded by the applet. For example, using the applet tag parameters in the applet's 30 modified HTML file, the applet 30 will learn the name of the manifest object 70 from the extension jar file 60. The applet 30 can use applet tag parameters in its modified HTML file to reach into the extension JAR file 60 and extract the page manifest object 70 from the extension JAR file 60. The page manifest object 70 includes a manifest which describes definitions of the new extension pages. The applet 30 loads the page manifest object 70 into memory of the applet 30 so that the page manifest object 70 can be used by the applet 30. At this point, a copy of the page manifest object 70 is instantiated in the memory of the applet 30.

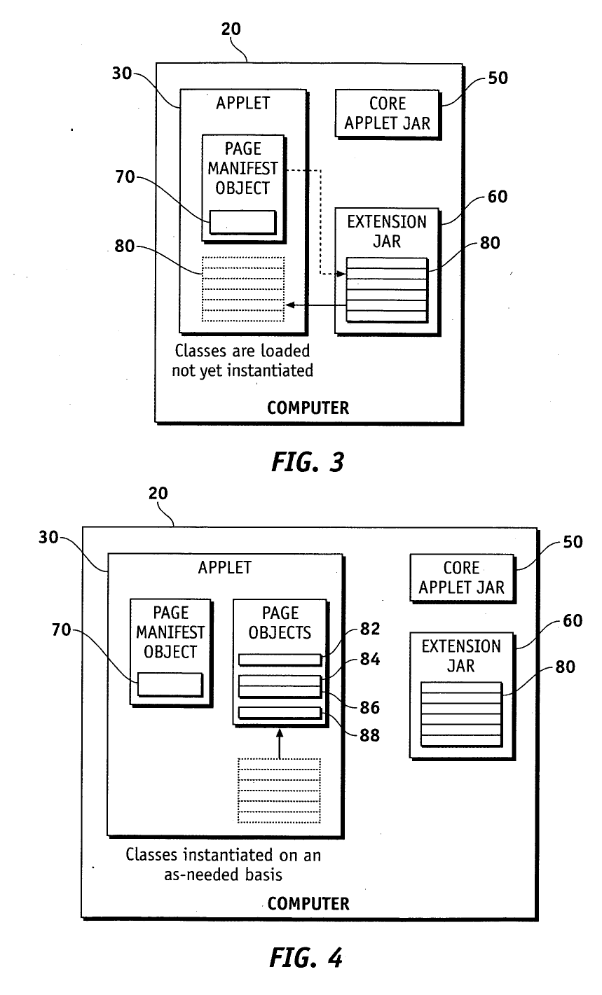

FIG. 3 is a block diagram of the applet extensibility system of FIGS. 1 and 2 which illustrates techniques for loading classes specified in the page manifest object 70 from the extension JAR file 60 into the applet 30.

Once the page manifest object 70 has been loaded into memory of the applet 30, the applet 30 opens the page manifest object 70 and reads a listing of new page classes 80 which comprise sub-modules within the extension JAR file 60. The new page classes 80 can implement a Java “page extension” interface for plug-in pages which defines the pluggable new extension pages included in the extension JAR file 60. The applet 30 reads definitions for all of the new page classes 80 specified in the page manifest object 70, and loads the new page classes 80 specified in the page manifest object 70 into the memory of the applet 30. At this point, the new page class 80 information is available; however, the page objects have not yet been instantiated.

FIG. 4 is a block diagram of the applet extensibility system of FIGS. 1 through 3 which illustrates techniques for plugging each of the new page classes 80 into the applet 30. Each of the new page classes 80 can then be instantiated and plugged into the applet framework including tree entries, according to information provided by the page manifest object 70. The applet 30 instantiates the new page classes 80 on as as-needed basis using information provided by the page manifest object 70. The actual instantiation can take place, for example, as each class 80 is needed when a user navigates the Web page. Upon instantiation, the page objects 82-88 come into existence. The page objects 82-88 comprise software components or modules for each of the individual extension pages. Other interfaces can be defined to implement helper objects as well. The helper objects implement a TreeInsertionPoint interface for each extension page that will be plugged into the applet 30. The TreeInsertionPoint interface describes the name of the tree where the new item should be installed, describes the tree, and provides a location within that tree where a given extension page should have a tree-item installed.

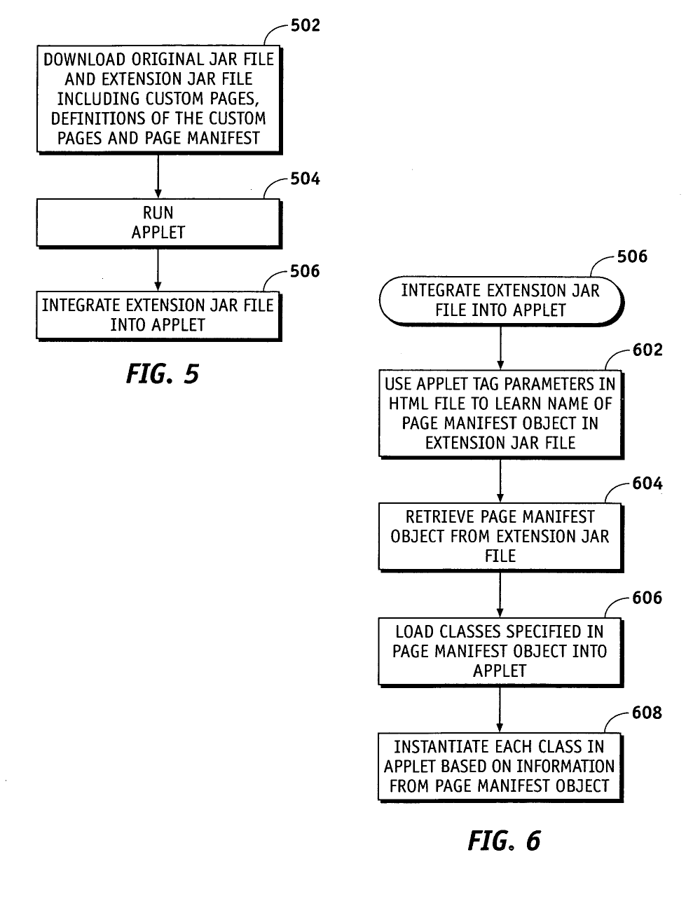

FIG. 5 is a flow chart showing an exemplary applet extensibility method of customizing an applet by adding custom pages to the applet without changing an original Java archive (JAR) file of the applet according to one exemplary embodiment. At step 502, a client computer downloads the original Java archive (JAR) file and an extension JAR file from a server. The extension JAR file comprises custom pages, and a page manifest object which implements an interface of page manifests and includes definitions of the custom pages. At step 504, when an HTML file launches the applet upon applet start-up, the client computer begins running the applet. At step 506, the applet integrates or “wires” the extension JAR file into the applet.

FIG. 6 is a flow chart showing an exemplary method of integrating an extension JAR file into an applet according to one exemplary embodiment. At step 602, the applet uses applet tag parameters in the HTML file to learn the name of the page manifest object in the extension JAR file. At step 604, the applet retrieves the page manifest object from the extension JAR file. At step 606, the applet loads classes specified in the page manifest object from the extension JAR file into the applet. The classes implement an interface for plug-in pages. At step 608, as each class is needed when the user navigates to the page, the applet instantiates each class in the applet based on information provided by the page manifest object.

Thus, numerous embodiments have been disclosed above which can provide techniques which allow for a Java-based applet extensibility architecture. This architecture can allow a third party, such as a vendor or developer, to extend the applet features.

The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical. Furthermore, numerical ordinals such as “first,” “second,” “third,” etc. simply denote different singles of a plurality and do not imply any order or sequence unless specifically defined by the claim language.

Those of skill would further appreciate that the various illustrative logical blocks, modules, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should also be understood that various changes can be made in the function and arrangement of elements without departing from the scope of the invention as set forth in the appended claims and the legal equivalents thereof. Thus, the present invention is not intended to be limited to the embodiments shown herein but is to be accorded the widest scope consistent with the principles and novel features disclosed herein.

What is claimed is:

1. An applet extensibility system for customizing an applet by adding custom pages to the applet without changing an original file of the applet, comprising:
a server having the original file and an extension file which comprises custom pages and an object; and
a client computer configured to download the original file and the extension file from the server, wherein the client computer has the applet running thereon, wherein the applet is configured to add the custom pages from the extension file into the applet by using applet tag parameters to determine the name of the object in the extension file, retrieving the object from the extension file, loading classes specified in the object from the extension file into the applet, and instantiating each class within the applet as a page object based on information provided by the object.

2. The applet extensibility system of claim 1, wherein the original file comprises an original Java archive (JAR) file and wherein the extension file comprises an extension JAR file.

3. The applet extensibility system of claim 2, wherein the object further comprises definitions of the custom pages.

4. The applet extensibility system of claim 3, wherein the object comprises a page manifest object.

5. The applet extensibility system of claim 4, wherein the page manifest object implements an interface of page manifests.

6. The applet extensibility system of claim 4, wherein the applet includes an HTML file, and wherein using applet tag parameters to determine the name of the object in the extension JAR file comprises:
using applet tag parameters in the HTML file to learn the name of the page manifest object in the extension JAR file.

7. The applet extensibility system of claim 6, wherein the classes implement an interface for plug-in pages.

8. The applet extensibility system of claim 7, wherein instantiating each class into the applet, comprises:
instantiating each class into the applet as a page object based on information provided by the page manifest object as each class is needed when the user navigates to the page

9. The applet extensibility system of claim 8, wherein the applet integrates the extension JAR file into the applet upon applet start-up.

10. An applet extensibility method for customizing an applet by adding custom pages to the applet without changing an original file of the applet, comprising:
downloading, to a client computer having the applet running thereon, the original file and an extension file comprising custom pages and an object;
integrating the extension file into the applet by:
using applet tag parameters to determine the name of the object in the extension file;
retrieving the object from the extension file;
loading classes specified in the object from the extension file into the applet; and
instantiating each class within the applet as a page object based on information provided by the object.

11. The applet extensibility method of claim 10, wherein the original file comprises an original Java archive (JAR) file and wherein the extension file comprises an extension JAR file.

12. The applet extensibility method of claim 11, wherein the object further comprises definitions of the custom pages.

13. The applet extensibility method of claim 12, wherein the object comprises a page manifest object.

14. The applet extensibility method of claim 13, wherein the page manifest object implements an interface of page manifests.

15. The applet extensibility method of claim 13, wherein the applet includes an HTML file, and wherein using applet tag parameters to determine the name of the object in the extension JAR file comprises:
using applet tag parameters in the HTML file to learn the name of the page manifest object in the extension JAR file.

16. The applet extensibility method of claim 15, wherein the classes implement an interface for plug-in pages.

17. The applet extensibility method of claim 16, wherein instantiating each class into the applet, comprises:
instantiating each class into the applet as a page object based on information provided by the page manifest object as each class is needed when the user navigates to the page.

18. The applet extensibility method of claim 17, wherein the applet integrates the extension JAR file into the applet upon applet start-up.

19. A computer-readable medium having computer-executable instructions stored thereon for performing a method of adding custom pages to a Graphical User Interface (GUI) applet without changing an original Java archive (JAR) file of the GUI applet, wherein the computer-readable medium includes an extension JAR file which comprises the custom pages and a page manifest object, and the method comprising:
retrieving the page manifest object from the extension JAR file;
loading classes specified in the page manifest object from the extension JAR file into the GUI applet; and
instantiating the classes within the GUI applet as page objects.

20. A set of application program interfaces embodied on a computer-readable medium for execution on a client computer in conjunction with an application program for customizing an applet on the client computer by adding custom pages to the applet from an extension JAR file without changing an original Java archive (JAR) file of the applet, wherein the extension JAR file comprises custom pages and a page manifest object which specifies classes associated with and definitions of the custom pages, comprising:
a first interface of page manifests associated with the page manifest object; and
a second interface for plug-in pages associated with classes specified in the page manifest object, wherein each class is plugged into the applet based on information provided by the page manifest object as each class is needed.
